(19) United States
(12) Patent Application Publication
(10) Pub. No.: US 2012/0075219 A1
(43) Pub. Date: Mar. 29, 2012

(54) DETECTION METHOD AND DETECTING APPARATUS FOR DETECTING MULTIPLE TOUCH POINTS ON TOUCH PANEL

(76) Inventors: Tung-Ke Wu, Taipei City (TW); Shih-Tzung Chou, Hsinchu County (TW); Shih-Chin Chang, Hsinchu City (TW)

(21) Appl. No.: 13/239,397

(22) Filed: Sep. 22, 2011

(30) Foreign Application Priority Data
Sep. 29, 2010 (TW) 099132998

(51) Int. Cl. G06F 3/041

(52) U.S. Cl. 345/173

(57) ABSTRACT

A detection method for detecting a plurality of contacts on a touch panel includes: generating a preliminary sensing data according to the contacts on the touch panel; determining a plurality of first specific sensing axes included in a plurality of first sensing axes and a plurality of f second specific sensing axes included in a plurality of second sensing axes according to the preliminary sensing data; utilizing a configuration circuit to configure a driving and receiving sequence of the plurality of first sensing axes and the plurality of second sensing axes for obtaining a first sensing data and a second sensing data; and utilizing a determining circuit to receive a completion instruction, wherein when the determining circuit receives the completion instruction, the determining circuit determines a touch detection result according to the first sensing data and the second sensing data.

### BACKGROUND OF THE INVENTION

1. Field of the Invention

The disclosed embodiments of the present invention relate to a contact detection scheme, and more particularly, to a detection method and detection device for detecting a plurality of contacts on a touch panel.

2. Description of the Prior Art

In a regular mutual capacitance touch panel, there are two common detection methods. The first detection method is orderly driving all sensing axis on a first dimension (e.g., X axis) on a touch panel and then orderly receiving a sensing signal corresponding each sensing axis on X axis through each sensing axis on a second dimension (e.g., Y axis), and then orderly driving each sensing axis on Y axis and orderly receive a sensing signal corresponding to each sensing axis on Y axis through each sensing axis on X axis. For example, please refer to FIG. 1, which is a schematic diagram of a conventional detection circuit 200 utilized to detect multiple contacts on a touch panel 100. As can be known from the figure, the conventional touch panel 100 has 8 sensing axes X1˜X8 and Y1˜Y8 on X axis and Y axis, respectively, wherein each sensing axis utilizes a multiplexer 210 to determine how the sensing axis is connected to an analog-digital converter (ADC) 220 and its working mode depend on a register device 211. When a driving circuit 250 is used to drive the sensing axis X1, the register device 211 is concurrently configured for utilizing the multiplexer 210 to receive a sensing signal corresponding to the sensing axis X1 on the sensing axis Y1, and then utilizing the ADC 220 to convert the sensing signal into a digital signal and store the digital signal in a storage element (e.g., memory) 230, such that it can be read by a processor (e.g. a micro control unit, MCU) through a control interface 240 later. Next, the conventional method keeps driving the sensing axis X1, and modifies the configuration of the sensing axis Y1 and Y2 in the register device 211 so as to stop the sensing axis Y1 from receiving any receiving signal. After that, the conventional method starts to receive a sensing signal corresponding to the sensing axis X1 on the sensing axis Y2, utilizes the ADC 220 to convert the sensing signal into a digital signal, and then utilizing the processor to read the digital signal via the control interface 240. By the same token, the following sensing signals would be received, stored, and read until all the sensing signals corresponding to the sensing axis X1 on the sensing axis Y1˜Y8 are read by the processor.

In FIG. 1, the conventional detection circuit 200 needs massive configurations and frequent data access for completely detecting a touch event on the touch panel 100. For example, if the detection circuit 200 scan all areas on the touch panel 100 to obtain coordinates of every contact included therein, it would be required to configure the register device 211 and access data through the control interface 240 for at least 8*8*2=128 times. Please refer to FIG. 2, which is a schematic diagram of a preliminary detection of multiple contact events on the touch panel 100, wherein the sensing signal corresponding to Y axis that is received on X axis is denoted as SX, and the sensing signal corresponding to X axis that is received on Y axis is denoted as SY. As can be known from the figure, the sensing signal SX indicates that there are contacts on the sensing axes X2, X3, X6 and X7, and the sensing signal SX indicates that there are contacts on the sensing axes Y2, Y3, Y4, Y5 and Y6. Thus, even a preliminary detection procedure is adapted to narrow down the scan range, the number of configurations and data accesses of the embodiment in FIG. 2 is still equal to at least 4*5*2=40.

Therefore, how to enhance touch event detection efficiency of a touch panel and reduce the number of configurations and data accesses required by the touch event detection is still an issue to be solved in this pertinent field.

### SUMMARY OF THE INVENTION

In accordance with exemplary embodiments of the present invention, a detection method and detection device for detecting a plurality of contacts utilizing a preliminary detection data are proposed to solve the above-mentioned problem. The detection method and detection device are capable of rapidly accomplishing the touch event detection and greatly reducing the number of configurations and data accesses required by the touch event detection.

According to a first aspect of the present invention, an exemplary detection method for detecting a plurality of contacts on a touch panel is disclosed. The touch panel includes a plurality of first sensing axes on a first dimension and a plurality of second sensing axes on a second dimension. The exemplary detection method includes: generating a preliminary sensing data according to the contacts on the touch panel; determining a plurality of first specific sensing axes included in the plurality of first sensing axes and a plurality of second specific sensing axes included in the plurality of second sensing axes according to the preliminary sensing data; utilizing a configuration circuit to configure a driving and receiving sequence of the plurality of first sensing axes and the plurality of second sensing axes for obtaining a first sensing data and a second sensing data; and utilizing a determining circuit to receive a completion instruction, wherein when the determining circuit receives the completion instruction, the determining circuit determines a touch detection result according to the first sensing data and the second sensing data. The step of utilizing a configuration circuit includes: utilizing a driving circuit to drive the plurality first specific sensing axes one-by-one; respectively receiving a sensing data corresponding to each of the plurality first specific sensing axes from the plurality of second sensing axes of the touch panel through a multiplexer, and accordingly obtaining the first sensing data; storing the first sensing data in a storage element; utilizing the driving circuit to drive the plurality second specific sensing axes one-by-one; respectively receiving a sensing data corresponding to each of the plurality second specific sensing axes from the plurality of first sensing axes of the touch panel through a multiplexer, and accordingly obtaining the second sensing data; and storing the second sensing data in the storage element.

According to a second aspect of the present invention, an exemplary detection device for detecting a plurality of contacts on a touch panel is disclosed. The touch panel includes a plurality of first sensing axes on a first dimension and a plurality of second sensing axes on a second dimension. The exemplary detection device includes a driving circuit, a multiplexer, a preliminary detection circuit, a sensing axis selection circuit, a storage element, a configuration circuit and a determining circuit. The driving circuit is for driving the plurality of first sensing axes and the plurality of second sensing axes. The multiplexer is for receiving at least a sensing data corresponding to the plurality of first sensing axes and the plurality of second sensing axes. The preliminary detection circuit is coupled to the driving circuit and the multiplexer, for utilizing the driving circuit and the multiplexer to generate a preliminary sensing data according to the contacts on the touch panel. The sensing axis selection circuit is coupled to preliminary detection circuit, for determining a plurality first specific sensing axes in the plurality of first sensing axes and a plurality second specific sensing axes in the plurality of second sensing axes according to the preliminary sensing data. The configuration circuit is coupled to the driving circuit, the multiplexer, the sensing axis selection circuit and the storage element, for configuring a driving and receiving sequence of the plurality of first sensing axes and the plurality of second sensing axes for obtaining a first sensing data and a second sensing data, controlling the multiplexer to obtain a first sensing data by respectively receiving a sensing data corresponding to each of the plurality of first specific sensing axes from the plurality of second specific sensing axes of the touch panel after controlling the driving circuit to drive the plurality of first specific sensing axes one-by-one, and storing the first sensing data in the storage element; and controlling the multiplexer to obtain a second sensing data by respectively receiving a sensing data corresponding to each of the plurality of second specific sensing axes from the plurality of first specific sensing axes of the touch panel after controlling the driving circuit to drive the plurality of second specific sensing axes one-by-one, and storing the second sensing data in the storage element. The determining circuit is coupled to the storage element, for receiving a completion instruction, wherein when the determining circuit receives the completion instruction, the determining circuit determines a touch detection result according to the first sensing data and the second sensing data in the storage element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional detection circuit utilized to detect multiple contacts on a touch panel.

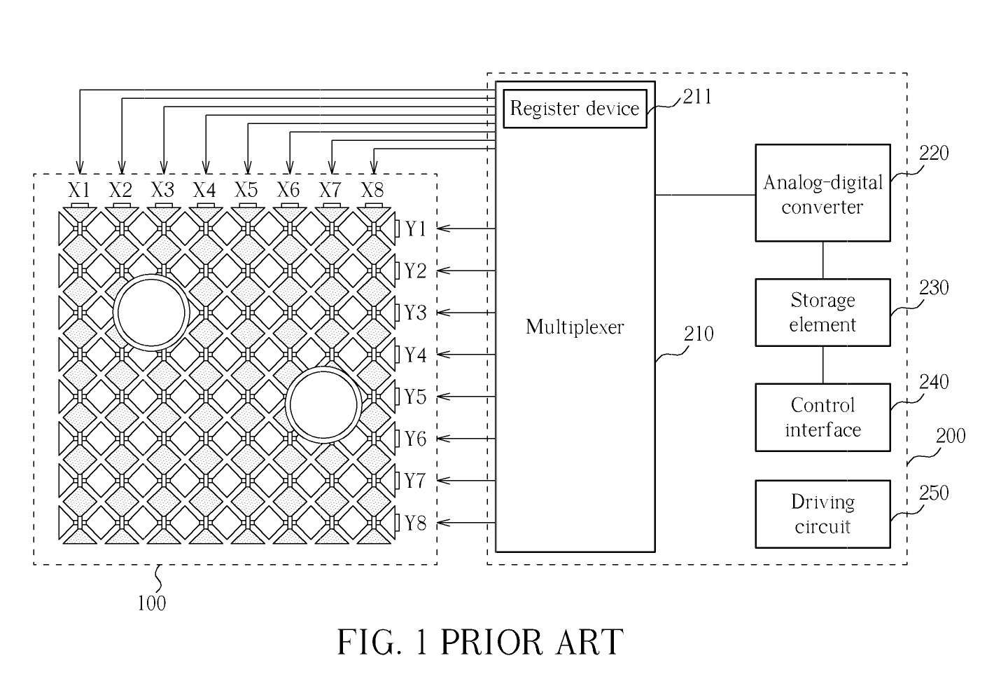

FIG. 2 is a schematic diagram of a preliminary detection of multiple contact events detected on a touch panel.

FIG. 3 is a schematic diagram of a detection device applied to a touch panel according to an embodiment of the present invention.

### DETAILED DESCRIPTION

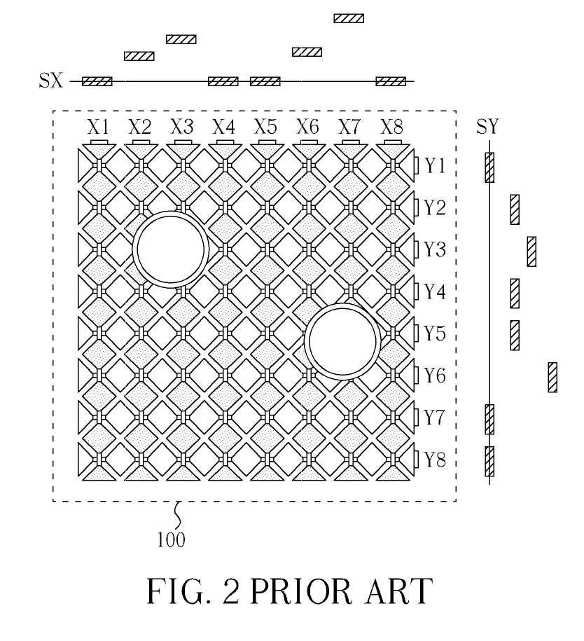

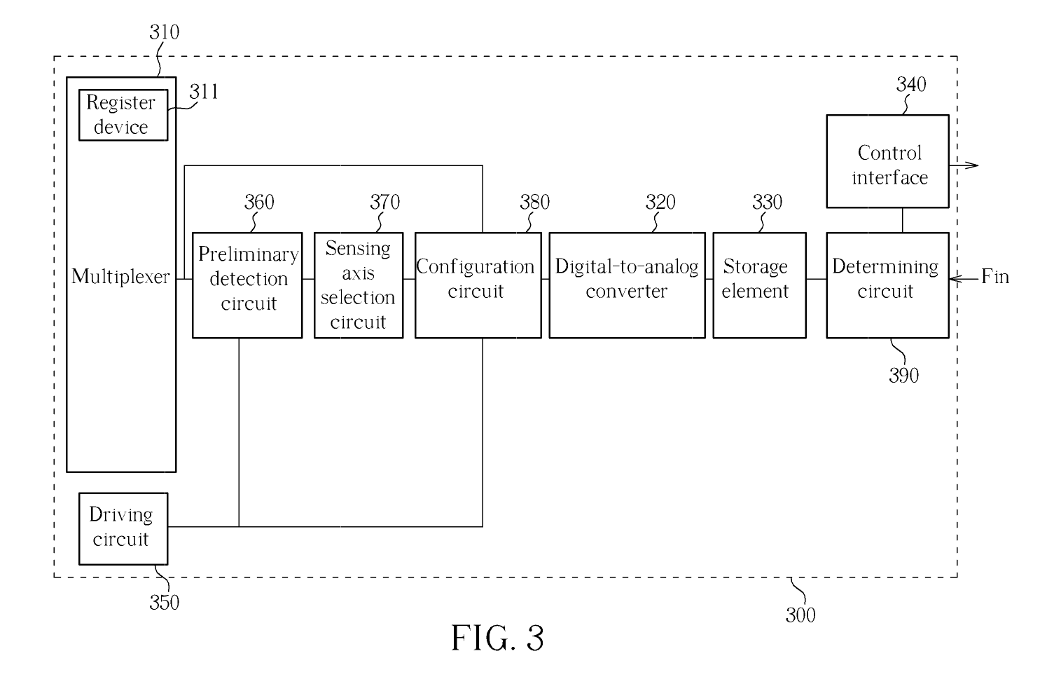

Please refer to FIG. 3, which is a schematic diagram of a detection device 300 applied to a touch panel according to an embodiment of the present invention. The touch panel includes a plurality of vertical sensing axes on a first dimension (e.g., X axis), and includes a plurality of horizontal sensing axes on a second dimension, (e.g., Y axis). For example, the detection device 300 is applied to the touch panel 100 shown in FIG. 2 to detect contacts thereon, wherein the touch panel 100 has first sensing axes X1˜X8 and second sensing axes Y1˜Y8. In this embodiment, the detection device 300 includes (but not limited to) a multiplexer 310, a digital-to-analog converter (DAC) 320, a storage element (e.g., memory) 330, a control interface 340, a driving circuit 350, a preliminary detection circuit 360, a sensing axis selection circuit 370, a configuration circuit 380 and a determining circuit 390. As the multiplexer 310 with a register device 311 included therein, the DAC 320, the storage element 330, the control interface 340 and the driving circuit 350 have structure and function substantially identical to that of the corresponding elements included in the conventional detection circuit 200, detailed operations are omitted hereinafter for brevity.

First, the preliminary detection circuit 360 would utilize the driving circuit 350 and the multiplexer 310 to generate a preliminary sensing data SP according to all contacts on the touch panel. For example, the driving circuit 350 is first used to concurrently drive the first sensing axes X1˜X8 of the touch panel 100, and the multiplexer 310 is controlled to receive corresponding sensing signal SY on the second sensing axes Y1˜Y8 of the touch panel 100; next, the driving circuit 350 is used to concurrently drive the second sensing axes Y1˜Y8, and the multiplexer 310 is controlled to receive corresponding sensing signal SX on the first sensing axes X1˜X8; and finally, the preliminary sensing data SP is generated according to the sensing signal SY and the sensing signal SX. As can be known from the exemplary embodiment in FIG. 2, the sensing signal SX indicates that only first sensing axes X2, X3, X6 and X7 among the first sensing axes have response signals, and the sensing signal SY indicates that only second sensing axes Y2, Y3, Y4, Y5 and Y6 among the second sensing axes have response signals. The sensing axis selection circuit 370 then determines a first specific sensing axis and a second specific sensing axis according to the sensing axes having response signals in the preliminary sensing data SP. In one embodiment, the sensing axis selection circuit 370 determines a plurality of first specific sensing axes in the first sensing axes X1˜X8 (i.e., the first sensing axes X2, X3, X6 and X7) and a plurality of second specific sensing axes in the second sensing axes Y1˜Y8 (i.e., the second sensing axes Y2, Y3, Y4, Y5 and Y6). Please note that, this is for illustrative purposes only and not meant to be limitations of the present invention. In another embodiment, the preliminary sensing data SP includes a first preliminary sensing data and a second preliminary sensing data, wherein the preliminary detection circuit 360 concurrently controls the driving circuit 350 to drive a plurality of first sensing axes, and controls the multiplexer 310 to respectively receive a first sensing data corresponding to each of the first sensing axes on a plurality of second sensing axes (e.g., the first sensing axes are X1˜X8, and the second sensing axes are Y1˜Y8; alternatively, if the first sensing axes are Y1˜Y8, the second sensing axes are X1˜X8) to thereby generate the first preliminary sensing data, and concurrently controls the driving circuit 350 to drive these second sensing axes, and controls the multiplexer 310 to respectively receive a second sensing data corresponding to each of the second sensing axes on these first sensing axes to thereby generate the second preliminary sensing data. In addition, the preliminary detection circuit 360 further performs a selection operation of sensing data to lower the possibility of misjudgment. For example, the preliminary detection circuit 360 generates the first preliminary sensing data according to each first sensing data exceeding a threshold value TH, and/or generates the second preliminary sensing data according to each second sensing data exceeding the threshold value TH.

After these specific sensing axes are determined, the configuration circuit 380 will set a driving and receiving sequence of these first specific sensing axes and these second specific sensing axes for generating a first sensing data and a second sensing data. First, the configuration circuit 380 determines the driving and receiving sequence according to these first specific sensing axes and these second specific sensing axes. For example, the configuration circuit 380 sets the driving circuit 350 to drive a first specific sensing axis X2, and sets the multiplexer 310 to use all the second specific sensing axes Y2˜Y6 to concurrently receive sensing data corresponding to the first specific sensing axis X2 (i.e., set corresponding second specific sensing axes Y2˜Y6 in the register device 311 to a read state), and store the sensing data in the storage element 330 through the DAC 320. Next, the driving circuit 350 is utilized to drive a next first specific sensing axis (i.e., first specific sensing axis X3), and concurrently set the multiplexer 310 to use all the second specific sensing axes Y2˜Y6 to concurrently receive sensing data corresponding to the first specific sensing axis X3 and then store the sensing data in the storage element 330. By the same token, the configuration circuit 380 would utilize the driving circuit 350 to drive the first specific sensing axes X2, X3, X6 and X7 one-by-one, and concurrently set the multiplexer 310 to respectively receive sensing data corresponding to the first specific sensing axes on the second specific sensing axes Y2˜Y6 to generate a first sensing data (i.e., a set of sensing data corresponding to the first specific sensing axes X2, X3, X6 and X7 respectively received on the second specific sensing axes Y2˜Y6) and then store the first sensing data in the storage element 330. Next, the configuration circuit 380 utilizes the driving circuit 350 to drive the second specific sensing axes Y2˜Y6 one-by-one, and concurrently set the multiplexer 310 to respectively receive sensing data corresponding to the second specific sensing axes on the first specific sensing axes X2, X3, X6 and X7 to generate a second sensing data and then store the second sensing data in the storage element 330. Finally, when the determining circuit 390 receives a finish command Fin, the determining circuit 390 determines a contact detection result according to the sensing output in the storage element 330, and outputs the contact detection result via the control interface 340 for determining these contacts corresponding to the touch event.

Please note that, in this embodiment, the detection device 300 uses the DAC 320 to digitally store the sensing data in the storage element 330; however, this is not meant to be limitations of the scope of the present invention. For example, the DAC 320 may be built in the multiplexer 310. Therefore, when the multiplexer 310 receives a sensing data corresponding to a sensing axis, the multiplexer 310 immediately outputs digitalized sensing data for the following processing.

In the aforementioned embodiment, besides the preliminary detection procedure, the configuration circuit 380 only needs to configure the multiplexer 310 and the driving circuit 350 twice, and can be interrupted in response to finish of the scanning operation or the finish command Fin manually sent by the user, such that a processor can read the contact detection result in a batch processing manner. In comparison with the conventional detection circuit 200, the number of configurations required by the detection device 300 according to the present invention is greatly reduced, thereby significantly lowering the scan time needed. Besides, the overall performance of the processor may be improved due to the fact that the processor is allowed to perform other operations during the scanning procedure.

To sum up, the present invention provides a detection method and related detection device which can rapidly read contact detection data and transmit it to a processor by configuring driving/sensing sequence of each sensing axis on a touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detection method for detecting a plurality of contacts on a touch panel, the touch panel comprising a plurality of first sensing axes on a first dimension and a plurality of second sensing axes on a second dimension, the detection method comprising:
generating a preliminary sensing data according to the contacts on the touch panel;
determining a plurality of first specific sensing axes included in the plurality of first sensing axes and a plurality of second specific sensing axes included in the plurality of second sensing axes according to the preliminary sensing data;
utilizing a configuration circuit to configure a driving and receiving sequence of the plurality of first sensing axes and the plurality of second sensing axes for obtaining a first sensing data and a second sensing data, comprising:
utilizing a driving circuit to drive the plurality first specific sensing axes one-by-one;
respectively receiving a sensing data corresponding to each of the plurality first specific sensing axes from the plurality of second sensing axes of the touch panel through a multiplexer, and accordingly obtaining the first sensing data;
storing the first sensing data in the storage element;
utilizing the driving circuit to drive the plurality second specific sensing axes one-by-one;
respectively receiving a sensing data corresponding to each of the plurality second specific sensing axes from the plurality of first sensing axes of the touch panel through a multiplexer, and accordingly obtaining the second sensing data; and
storing the second sensing data in the storage element; and
utilizing a determining circuit to receive a completion instruction, wherein when the determining circuit receives the completion instruction, the determining circuit determines a touch detection result according to the first sensing data and the second sensing data.

2. The detection method of claim 1, wherein the preliminary sensing data comprises a first preliminary sensing data and a second preliminary sensing data, the plurality first specific sensing axes are selected from the plurality of first sensing axes based on the first preliminary sensing data, the plurality second specific sensing axes are selected from the plurality of second sensing axes based on the second preliminary sensing data, and the step of generating the preliminary sensing data comprises:
concurrently driving the plurality of first sensing axes, and generating the first preliminary sensing data by respectively receiving a first sensing data corresponding to each of the plurality first sensing axes from the plurality of second sensing axes; and
concurrently driving the plurality of second sensing axes, and generating the second preliminary sensing data by respectively receiving a second sensing data corresponding to each of the plurality second sensing axes from the plurality of first sensing axes.

3. The detection method of claim 2, wherein the step of generating the first preliminary sensing data comprises:
generating the first preliminary sensing data according to first sensing data each exceeding a threshold value.

4. The detection method of claim 3, wherein the step of generating the second preliminary sensing data comprises:
generating the second preliminary sensing data according to second sensing data each exceeding the threshold value.

5. A detection device for detecting a plurality of contacts on a touch panel, the touch panel comprising a plurality of first sensing axes on a first dimension and a plurality of second sensing axes on a second dimension, the detection device comprising:
a driving circuit, for driving the plurality of first sensing axes and the plurality of second sensing axes;
a multiplexer, for receiving at least a sensing data corresponding to the plurality of first sensing axes and the plurality of second sensing axes;
a preliminary detection circuit, coupled to the driving circuit and the multiplexer, for utilizing the driving circuit and the multiplexer to generate a preliminary sensing data according to the contacts on the touch panel;
a sensing axis selection circuit, coupled to preliminary detection circuit, for determining a plurality first specific sensing axes in the plurality of first sensing axes and a plurality second specific sensing axes in the plurality of second sensing axes according to the preliminary sensing data;
a storage element;
a configuration circuit, coupled to the driving circuit, the multiplexer, the sensing axis selection circuit and the storage element, for configuring a driving and receiving sequence of the plurality of first sensing axes and the plurality of second sensing axes for obtaining a first sensing data and a second sensing data; controlling the multiplexer to obtain a first sensing data by respectively receiving a sensing data corresponding to each of the plurality of first specific sensing axes from the plurality of second specific sensing axes of the touch panel after controlling the driving circuit to drive the plurality of first specific sensing axes one-by-one, and storing the first sensing data in the storage element;
and controlling the multiplexer to obtain a second sensing data by respectively receiving a sensing data corresponding to each of the plurality of second specific sensing axes from the plurality of first specific sensing axes of the touch panel after controlling the driving circuit to drive the plurality of second specific sensing axes one-by-one, and storing the second sensing data in the storage element; and
a determining circuit, coupled to the storage element, for receiving a completion instruction, wherein when the determining circuit receives the completion instruction, the determining circuit determines a touch detection result according to the first sensing data and the second sensing data in the storage element.

6. The detection device of claim 5, wherein:
the preliminary sensing data comprises a first preliminary sensing data and a second preliminary sensing data;
the sensing axis selection circuit selects the plurality first specific sensing axes from the plurality of first sensing axes based on the first preliminary sensing data, and selects the plurality second specific sensing axes from the plurality of second sensing axes based on the second preliminary sensing data; and
the driving circuit concurrently drives the plurality of first sensing axes, and the configuration circuit controls the multiplexer to respectively receive a first sensing data corresponding to each of the plurality of first sensing axes from the plurality of second sensing axes, to generate the first preliminary sensing data; and
the driving circuit concurrently drives the plurality of second sensing axes, and the configuration circuit controls the multiplexer to respectively receive a second sensing data corresponding to each of the plurality of second sensing axes from the plurality of first sensing axes, to generate the second preliminary sensing data.

7. The detection device of claim 6, wherein the preliminary detection circuit generates the first preliminary sensing data according to first sensing data each exceeding a threshold value.

8. The detection device of claim 7, wherein the preliminary detection circuit further generates the second preliminary sensing data according to second sensing data each exceeding the threshold value.
